(19) United States
(12) Patent Application Publication
(10) Pub. No.: US 2018/0106551 A1
(43) Pub. Date: Apr. 19, 2018

(54) Heat Exchanger for a Device that Produces Combustible Product Gas from Carbon-Containing Input Materials

(71) Applicant: Entrade Energiesysteme AG, Duesseldorf (DE)

(72) Inventors: Michael Hofmeister, Rinchnach (DE); Horst Dressler, Dietfurt (DE)

(21) Appl. No.: 15/836,844

(22) Filed: Dec. 9, 2017

Related U.S. Application Data
(63) Continuation-in-part of application No. PCT/EP2016/063507, filed on Jun. 13, 2016.

(30) Foreign Application Priority Data
Jun. 12, 2015 (DE) 102015210826.0
Jun. 13, 2016 (EP) PCT/EP2016/063507

(51) Int. Cl. F28D 7/10; F28D 7/02; F28D 21/00; F28F 1/36; F28F 9/22

(52) U.S. Cl. CPC F28D 7/106; F28D 7/026; F28D 7/1607; F28F 1/36; F28F 9/22; F28D 21/0008

(57) ABSTRACT

A heat exchanger for cooling product gas generated from biomass includes a cylindrical main body, a rod-shaped component, a gas inlet and a gas outlet. The cylindrical main body has a circumferential cladding. An annular flow channel is formed in the cylindrical main body around the rod-shaped component, which extends axially in the main body. The gas inlet and gas outlet are disposed towards opposite ends of the main body. The gas inlet is tubular and enters the annular flow channel tangentially to the circumferential cladding and perpendicularly to the axial direction of the cylindrical main body. The velocity of the cooling product gas is maintained by making the cross-sectional area of the gas outlet smaller than that of the gas inlet. A helical shaped guide plate is disposed in the annular flow channel and has an outer circumferential edge that seals against an inner surface of the circumferential cladding.

### CROSS REFERENCE TO RELATED APPLICATION

This application is filed under 35 U.S.C. § 111(a) and is based on and hereby claims priority under 35 U.S.C. § 120 and § 365(c) from International Application No. PCT/EP2016/063507, filed on Jun. 13, 2016, and published as WO 2016/198693 A1 on Dec. 15, 2016, which in turn claims priority from German Application No. 102015210826.0, filed in Germany on Jun. 12, 2015. This application is a continuation-in-part of International Application No. PCT/EP2016/063507, which is a continuation of German Application No. 102015210826.0. International Application No. PCT/EP2016/063507 is pending as of the filing date of this application, and the United States is an elected state in International Application No. PCT/EP2016/063507. This application claims the benefit under 35 U.S.C. § 119 from German Application No. 102015210826.0. The disclosure of each of the foregoing documents is incorporated herein by reference.

### TECHNICAL FIELD

The invention relates to a heat exchanger component and a heat exchanger system comprising a plurality of the heat exchanger components that control the temperature of a gas flow containing solid particles. The invention also relates to a device that includes such a heat exchanger system and produces a combustible product gas from carbon-containing input materials.

### BACKGROUND

Gas flows that contain solid particles include flue gas produced by combustion systems, product gas streams generated by chemical reactors and also combustible product gas produced from carbon-containing solid particles. For example, combustible product gas is generated through wood gasification and coal gasification. The hot gas flows that include solid particles must generally be cooled. If this cooling is carried out in conventional liquid-gas heat exchangers, there is a danger that the solid particles will be partially deposited in the heat exchanger and thus will significantly reduce the efficiency of the heat transfer. Moreover, the operating time is reduced because the heat exchangers must periodically be cleaned.

Japanese patent JP H1162723A and European patent EP 1884634A2 describe heat exchangers for an exhaust. The heat exchanger for exhaust gas of Japanese patent application JP 2000111277A has cooling ribs in a longitudinal direction. Austrian patent AT 371591B discloses a heat exchanger, in particular for injection molding machines and die casting machines. The heat exchanger has a helical heat transfer body that can be heated or cooled. Heating elements and a coolant feed tube protrude into the hollow core of the helical heat transfer body.

United States patent application publication US 2008/0190593A1 discloses a heat exchanger that has helical guide plates with inner and outer parts. The helical guide plates are penetrated by tubes through which a heat exchange medium flows for heat exchange. U.S. Pat. No. 6,827,138 discloses a heat exchanger that has quadrant baffles arranged in the form of a helix.

A problem with these known heat exchangers is that the volume of the gas flow is reduced by cooling the gas flow in the heat exchanger component. The reduced gas flow also reduces the flow velocity. Consequently, the centrifugal forces in the helical gas stream are reduced, the thickness of the Prandtl boundary layer increases, and the heat transfer coefficient drops.

It is an object of the present invention to provide a heat exchanger component, and a heat exchanger system that includes such heat exchanger components, that pollutes less by controlling the temperature of gas flows and in particular by cooling gas flows that include solid particles, while also exhibiting a large heat transfer capacity. Moreover, it is also an object of the present invention to provide a device for producing a combustible product gas from carbon-containing input materials that includes such a heat exchanger system.

### SUMMARY

A heat exchanger component is disclosed that controls the temperature of the flow of gas that contains solid particles, such as a gas generated by a device that produces a combustible product gas from carbon-containing input materials. A heat exchanger system is also disclosed that includes a plurality of the heat exchanger components.

Gas flows that are mixed with solid particles occur in the form of flue gas and product gas streams. The hot gas flows that contain solid particles must generally be cooled. If this cooling is carried out in conventional liquid-gas heat exchangers, there is a danger that the solid particles will be partially deposited in the heat exchanger and thus significantly reduce the efficiency of the heat transfer. By designing the gas inlet and the gas outlet to enter and exit tangentially and transversely to the flow channel of the heat exchanger component, a helical shaped gas stream is generated inside the flow channel around the middle of the cylindrical main body of the heat exchanger component. The velocity of the gas flow is maintained by making the cross-sectional area of the gas outlet smaller than the cross-sectional area of the gas inlet so as to compensate for the reduced volume of the gas as it cools.

The high velocity of the gas flow is thereby maintained so that the Prandtl boundary layer on the inner side of the cladding of the cylindrical main body is comparatively thin. This significantly increases the heat transfer between the cladding and the environment because the outer side of the cladding releases more heat. Because the high velocity results in large centrifugal forces, the solid particles in the gas concentrate in a narrow region on the inner side of the cladding, and the probability of particle collisions and the caking of smaller particles into larger particles increases sharply. Larger solid particles are easier to separate using downstream filters. Due to the high flow velocity and the associated turbulent flow, the depositing of solid particles on the inner side of the cladding is prevented.

A heat exchanger component for cooling product gas generated from carbon-containing input materials includes a cylindrical main body, a rod-shaped component, a gas inlet and a gas outlet. The cylindrical main body has a circumferential cladding. An annular flow channel is formed in the cylindrical main body around the rod-shaped component, which extends axially in the cylindrical main body. The gas inlet and gas outlet are disposed towards opposite ends of the cylindrical main body. The gas inlet is tubular and enters the annular flow channel tangentially to the circumferential cladding and perpendicularly to the axial direction of the cylindrical main body. The velocity of the gas flow is maintained despite the decreasing volume as the product gas cools by making the cross-sectional area of the gas outlet smaller than that of the gas inlet.

In one embodiment, a helical shaped guide plate is disposed in the annular flow channel and has an outer circumferential edge that seals tightly against an inner surface of the circumferential cladding. The inner circumferential edge of the helical shaped guide plate fits tightly around the rod-shaped component. In another embodiment, the cylindrical main body is coaxially oriented inside an outer cylindrical container that forms a channel between the circumferential cladding and the outer cylindrical container. A heat transfer medium is disposed in the channel and transforms the heat exchanger component without the outer container from a gas-gas heat exchanger to a gas-liquid heat exchanger, which has a higher heat transfer performance.

A heat exchanger system includes multiple heat exchanger components. For example, a heat exchanger system with two heat exchanger components includes a first cylindrical main body with a first circumferential cladding and a second cylindrical main body with a second circumferential cladding. A first gas inlet and a first gas outlet are disposed towards opposite sides of the first cylindrical main body. The first gas inlet enters the first cylindrical main body tangentially to the first circumferential cladding. The cross-sectional area of the first gas inlet is larger than that of the first gas outlet. A second gas inlet and a second gas outlet are disposed towards opposite ends of the second cylindrical main body. The second gas inlet is connected to the first gas outlet and has the same cross-sectional area as that of the first gas outlet. The second gas inlet enters the second cylindrical main body tangentially to the second circumferential cladding. The cross-sectional area of the second gas inlet is larger than that of the second gas outlet.

A first rod-shaped component extends axially in the first cylindrical main body, and a second rod-shaped component extends axially in the second cylindrical main body. A first annular flow channel is formed around the first rod-shaped component in the first cylindrical main body, and a second annular flow channel is formed around the second rod-shaped component in the second cylindrical main body. The second annular flow channel has a cross-sectional area that is smaller than that of the first annular flow channel.

A gasifier device for producing a product gas from carbon-containing material includes a gasifier component whose diameter is smaller than the diameter of a gasifier container in which the gasifier component is coaxially positioned. The upper closed end of the gasifier component projects up and out of the gasifier container. A supply inlet is adapted to receive the carbon-containing material into the upper closed end of the gasifier component. An air supply inlet enters the gasifier component near the upper closed end and is used to feed combustion air into the gasifier component. A rotary grate is disposed in the lower portion of the gasifier container and is adapted to support the carbon-containing material. A product gas vent leads out of the gasifier container below the grate. The product gas generated from the carbon-containing material exits the gasifier container through the product gas vent.

A heat exchanger component includes a gas inlet, a gas outlet and a cylindrical main body. The gas inlet is connected to the product gas vent and enters the heat exchanger component tangentially to the cylindrical main body. Product gas containing solid particles, such as ash from the carbon-containing material, enters the heat exchanger component through the gas inlet. The cross-sectional area of the gas inlet is larger than the cross-sectional area of the gas outlet.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic, cross-sectional view of a first embodiment of a heat exchanger component in accordance with the present invention.

FIG. 2 is a schematic sectional view along the line A-A of FIG. 1.

FIG. 3 shows a second embodiment of a heat exchanger component.

FIG. 4 is a schematic cross-sectional view of an exemplary configuration of a heat exchanger system that includes three heat exchanger components according to FIG. 1.

FIG. 5 is a schematic cross-sectional view of a device for producing a combustible product gas from carbon-containing input materials that includes a heat exchanger system according to FIG. 4.

FIG. 6A is a side view of a helical shaped guide plate.

FIG. 6B is a view in the flow direction of the helical shaped guide plate.

FIG. 6C is a perspective view of the helical shaped guide plate.

### DETAILED DESCRIPTION

Reference will now be made in detail to some embodiments of the invention, examples of which are illustrated in the accompanying drawing.

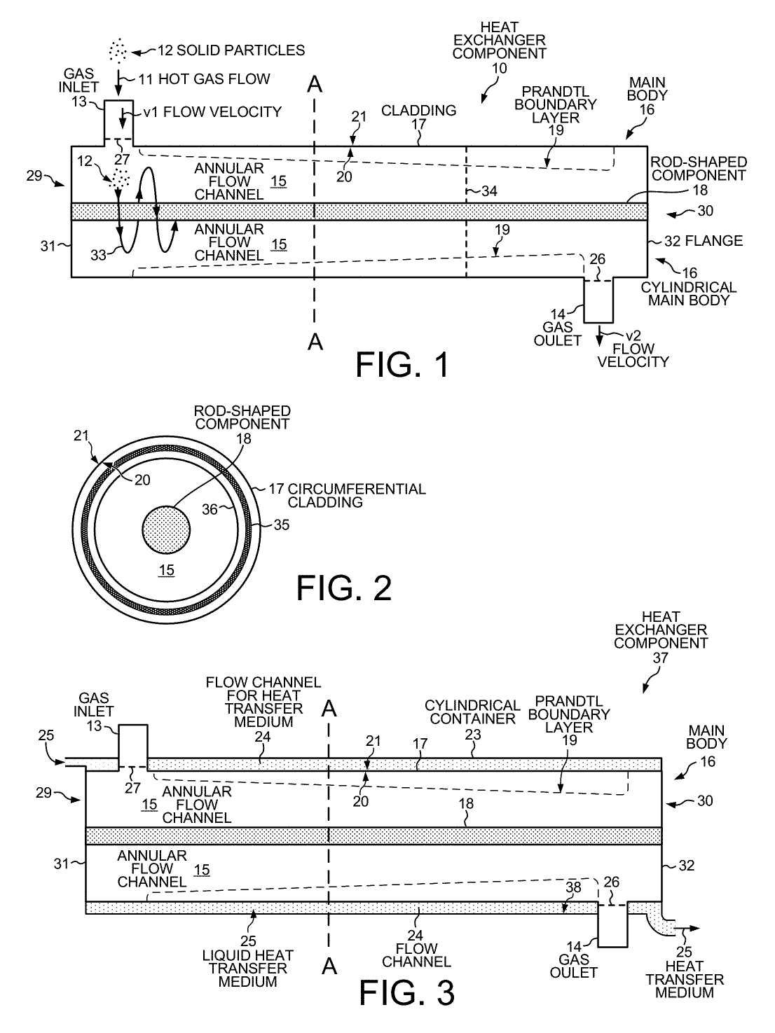

FIG. 1 shows a first embodiment of a heat exchanger component 10 for cooling a hot gas flow 11 that contains solid particles 12. The gas inlet 13 of the heat exchanger component 10 has a constant first cross-sectional area along its length, and the gas outlet 14 has a constant second cross-sectional area along its length. The first cross-sectional area is larger than the second cross-sectional area.

The cross-sectional area of the gas outlet 14 is made smaller than the cross-sectional area of the gas inlet 13 to account for the fact that the volume of the gas flow decreases as the gas flow cools in the heat exchanger component 10. The flow velocity of the gas flow 11 would decrease if the cross-sectional area and initial flow volume were maintained constant while the temperature of the gas flow 11 decreases. By making the cross-sectional area of the gas outlet 14 smaller than that of the gas inlet 13, the flow velocity at the gas outlet 14 is made to equal approximately the flow velocity at gas inlet 13.

The gas inlet 13 enters tangentially and transversely into an annular flow channel 15 of the cylindrical main body 16 of the heat exchanger component 10. The gas outlet 14 also exits the cylindrical main body 16 transversely and tangentially from the annular flow channel 15. The gas inlet 13 and the gas outlet 14 pass through the cylindrical outer cladding 17 of the main body 16. By allowing the gas flow 11 to enter the annular flow channel 15 tangentially, a screw-thread, cyclone or helical shaped gas stream is generated inside the flow channel 15 that travels in a helix around a rod-shaped member 18 oriented axially in the cylindrical main body 16.

The flow velocity of the gas flow 11 that includes solid particles 12 is very high in the vicinity of the gas inlet 13, which allows the Prandtl boundary layer 19 on the inner side 20 of the circumferential cladding 17 of the main body 16 to be comparatively thin. The Prandtl boundary layer 19 is compressed by the high centrifugal forces resulting from the high flow velocity. This significantly increases the heat transfer between the gas flow 11 and the cladding 17 such that the outer side 21 of the cladding 17 releases more heat to the environment. Because of the high centrifugal forces, the solid particles 12 also concentrate in a narrow region on the inner side 20 of the cladding 17, thereby sharply increasing the probability of particle collisions and the caking of smaller particles into larger particles. Larger solid particles are easier to separate using downstream filters. Finally, due to the high flow velocity and the associated turbulence of the flow, solid particles 12 are prevented from being deposited on the inner side 20 of the circumferential cladding 17, which would more likely occur with a laminar flow.

The disclosed configuration of the heat exchanger component 10 promotes the formation and maintenance of the desired helical gas flow 11 within the annular flow channel 15. Specifically, the heat exchanger component 10 is configured such that the gas inlet 13 and the gas outlet 14 lead into the cylindrical main body 16 tangentially and perpendicularly to the longitudinal direction of the cylindrical main body 16.

In another embodiment, a helical (screw-thread shaped) guide plate 22 is disposed in the cylindrical main body 16 and maintains a helical gas stream through the heat exchanger component 10. The helical shaped guide plate 22 may have one or more windings. A plurality of helical shaped guide plates may also be used. It is beneficial for the helical shaped guide plates to have one or just a few windings because the greater the number of windings, the more pressure of the gas stream is lost in the heat exchanger, which is undesirable. For this reason, it is advantageous to provide just one helical shaped guide plate per heat exchanger component 10.

By designing the gas inlet 13 and gas outlet 14 to open transversely and tangentially into the flow channel 15, a helical flow of gas is created inside the flow channel 15 that travels around the center rod-shaped component 18 of the main body 16. The helical shaped gas stream is maintained in the flow channel 15 by the helical shaped guide plate 22 that tightly surrounds the rod-shaped component 18 and extends outwards to the inner side 20 of the circumferential cladding 17.

FIG. 3 shows the main body 16 of the heat exchanger component 10 surrounded by a cylindrical container 23. Surrounding the cylindrical main body 16 with the cylindrical container 23 creates an annular flow channel 24 for a liquid heat transfer medium 25. Using the liquid heat transfer medium 25 converts the heat exchanger component 10 from a gas-gas heat exchanger to a gas-liquid heat exchanger, which has a higher heat transfer performance.

The volume of the gas flow 11 decreases as the gas flow 11 in the heat exchanger component 10 cools, thereby also reducing the flow velocity. To compensate for the reduced flow velocity, the cross-sectional area 26 of the gas outlet 14 is made smaller than the cross-sectional area 27 of the gas inlet 13. The flow velocity at the gas inlet 13 can be made approximately equal to the flow velocity in the gas outlet 14 by sufficiently reducing the cross-sectional area 26 of the gas outlet 14 compared to that of the gas inlet 13.

The reduction in the volume of the gas flow 11 resulting from the heat extraction causes the flow velocity to drop between the gas inlet 13 and the gas outlet 14. In addition, as the centrifugal forces in the helical shaped gas flow 11 decrease with decreased flow velocity from the gas inlet 13 to the gas outlet 14, the heat transfer coefficient drops, and the thickness of the Prandtl boundary layer 19 increases, as shown in FIGS. 1 and 3. In order to compensate for the reduced volume of gas flow 11 and the slower flow velocity caused by the cooling gas, a plurality of heat exchanger components are connected in series to form a heat exchanger system 28.

The heat exchanger system 28 is formed by connecting the gas outlet 14 of the ith heat exchanger component to the gas inlet 13 of the (i+1)th heat exchanger component. Because the cross-sectional area of the gas outlet 14 of the ith heat exchanger component (also the gas inlet 13 of the (i+1)th heat exchanger component) is made smaller than the cross-sectional area of the gas inlet 13 of the ith heat exchanger component, the gas flow 11 is accelerated back to the original flow velocity. By maintaining the original high flow velocity, high centrifugal forces are again present in the region of the gas inlet 13 of the (i+1)th heat exchanger component, and the Prandtl boundary layer 19 is tightly pressed to the inner side 20 of the cladding 17 of the main body 16 of the (i+1)th heat exchanger component.

As the volume of the gas flow 11 decreases from cooling in successive downstream heat exchanger components of the heat exchanger system 28, the volume of the annular flow channel in each successive step of the heat exchanger system 28 is decreased in order to prevent the flow velocity from decreasing.

By using the heat exchanger system 28 in a device for producing a combustible product gas from carbon-containing input materials, the gas producing device becomes more efficient. For the same gas production, the size of the heat exchanger system can be smaller on account of the compactness of the design of the linked heat exchanger components.

FIG. 1 shows the first embodiment of the heat exchanger component 10 for cooling a hot gas flow 11 that contains solid particles 12. The heat exchanger component 10 is a gas-air heat exchanger in which the heat from the product gas flowing through the heat exchanger is released into the ambient air. The heat exchanger component 10 includes a cylindrical main body 16 that is surrounded by a cladding 17. The left side 29 and the right side 30 of the main body 16 as shown in FIG. 1 are closed by flanges 31-32. The cladding 17 has an inner side 20 and an outer side 21 and is made of a material of good thermal conductivity, such as a metal. The gas inlet 13 leads into the main body 16 near the left side 29 perpendicular to the longitudinal direction of the main body 16 and tangentially to the outer circumference of the main body 16. The gas outlet 14 leads out of the main body 16 near the right side 30 perpendicular to the longitudinal direction of the main body 16. Along its length, the gas inlet 13 has a constant first cross-sectional area 27. The gas outlet 14 has a constant second cross-sectional area 26. The cross-sectional area 26 of the gas outlet 14 is larger than the cross-sectional area 27 of the gas inlet 13. The rod-shaped component 18 has a circular cross-section and is arranged axially in the middle of the cylindrical main body 16. The component 18 is attached to both flanges 31-32.

A helical gas stream 33 is created in the annular flow channel 15 around the rod-shaped member 18 by orienting the gas inlet 13 tangentially into the annular flow channel 15. The cross-sectional area 34 of the annular flow channel 15 is constant between the gas inlet 13 and the gas outlet 14. In this way, the flow velocity v of the gas flow 11 containing solid particles 12 is sufficiently high in the vicinity of the gas inlet 13 so that the Prandtl boundary layer 19 on the inner side 20 of the cladding 17 of the main body 16 is comparatively thin, as shown in FIG. 1. Because of the high centrifugal forces created by the high flow velocity v, the Prandtl boundary layer 19 is compressed. Compressing the Prandtl boundary layer 19 near to the inner side 20 of the cladding 17 significantly increases the heat transfer between the gas flow 11 and the cladding 17 such that the outer side 21 of the cladding 17 releases more heat to the environment.

FIG. 2 is a cross-sectional view of the main body 16 of FIG. 1 along the line A-A and illustrates the location of the solid particles 12 in the annular flow channel 15. The large centrifugal forces created by the helical gas stream 33 of the gas flow 11 concentrate the solid particles 12 in a narrow region towards the inner side 20 of the cladding 17. The heavier particles 35 concentrate closer to the inner side 20 of the cladding 17, whereas the lighter particles 36 are located at a slightly greater distance from the inner side 20. The centrifugal forces that spin the particles 12 towards the inner side 20 greatly increase the probability of particle collisions and the caking of smaller particles into larger particles. The larger and also heavier particles 35 are easier to separate using downstream filters. The high flow velocity v of the gas flow 11 also tends to prevent the solid particles 12 from depositing on the inner side 20 of the cladding 17, which is more likely to occur with a laminar flow as opposed to with the more turbulent helical flow 33.

Because heat is continuously withdrawn from the gas flow 11 through the cladding 17, the volume of the gas flow 11 is continuously reduced, while the mass flow remains constant. The reduction in the volume of the gas flow 11 reduces the flow velocity v, and consequently also the centrifugal forces of the gas flow 11. With reduced flow velocity v, the thickness of the Prandtl boundary layer 19 increases, and the heat transfer coefficient of the cladding 17 is reduced between the gas inlet 13 and the gas outlet 14. The increase in the thickness of the Prandtl boundary layer 19 from the gas inlet 13 towards the gas outlet 14 is illustrated in FIG. 1 as a dashed line along the inner side 20 of the cladding 17. The decrease in the flow velocity v from the gas inlet 13 towards the gas outlet 14 is compensated for by reducing the cross-sectional area 26 of the gas outlet 14 compared to that of the gas inlet 13. Consequently, the flow velocity v2 at the gas outlet 14 is approximately the same as the flow velocity v1 at the gas inlet 13.

FIG. 3 shows a second embodiment of a heat exchanger component 37 that, in contrast to the first embodiment of heat exchanger component 10, is designed as a gas-liquid heat exchanger. The heat exchanger component 37 is distinguished from the heat exchanger component 10 of FIG. 1 in that the cylindrical main body 16 is coaxially embedded in an outer cylindrical container 23, which creates a circular flow channel 24. A liquid heat transfer medium 25, such as water, is disposed in the flow channel 24 between the outer side 21 of the cladding 17 and the inner side 38 of the cylindrical container 23. The heat transfer medium 25 turbulently flows through the annular flow channel 24 and considerably improves the performance of the heat exchanger component 37 compared to that of the heat exchanger component 10.

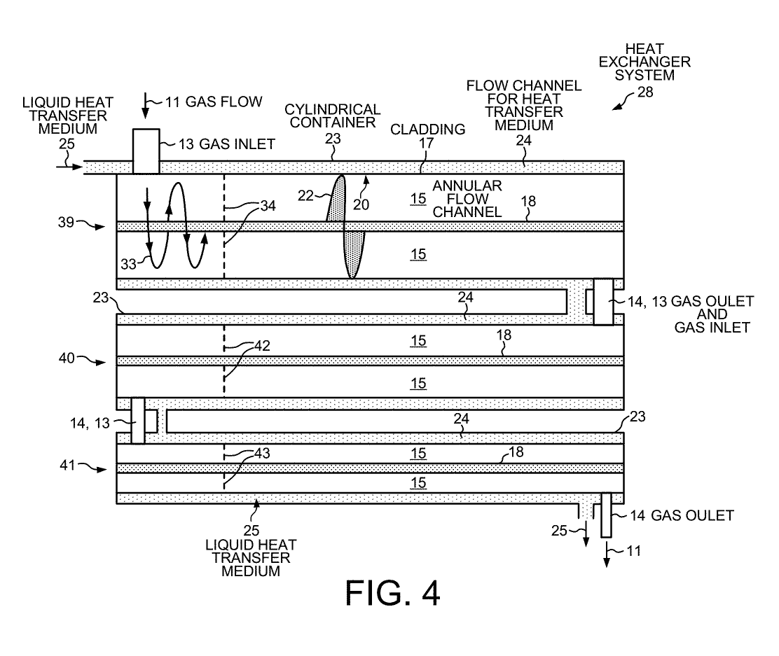

FIG. 4 shows an exemplary configuration of a heat exchanger system 28 that includes three heat exchanger components 39-41 of the type shown in FIG. 3. The three heat exchanger components 39-41 are connected in series one behind the other, so that the gas outlet 14 of the first heat exchanger component 39 becomes the gas inlet 13 of the second heat exchanger component 40, and the gas outlet 14 of the second heat exchanger component 40 becomes the gas inlet 13 of the third heat exchanger component 41.

The cross-sectional areas 34, 42 and 43 of the annular flow channels 15 of the three heat exchanger components 39, 40 and 41, respectively, are successively smaller. Due to the reduction of the cross-sectional areas 34, 42 and 43 from one heat exchanger component downstream to the next, the reduction of the volume of the gas flow 11 on account of the cooling is offset. By reducing the cross-sectional areas 26 of the gas outlets 14 of successive downstream heat exchanger components compared to the cross-sectional area 27 of the gas inlet 13 of each component, the flow velocity v at the gas inlet 13 of each downstream component is held constant, and the conditions of the centrifugal forces in each annular flow channel are approximately the same.

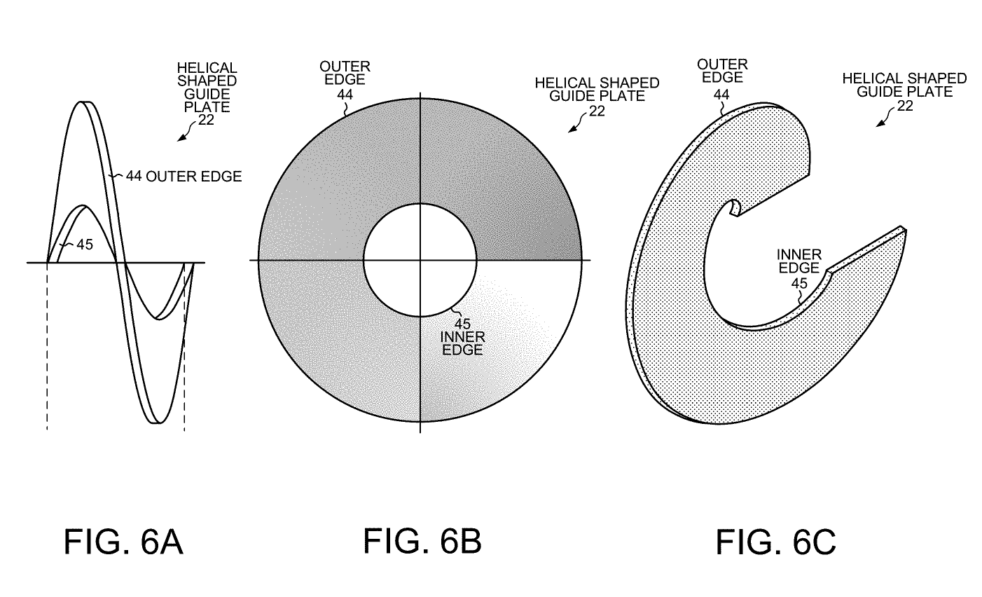

In FIG. 4, a helical shaped guide plate 22 is arranged in the annular flow channel 15 of the first heat exchanger component 39. Helical guide plate 22 is shown in more detail in FIGS. 6A, 6B and 6C. The helical gas stream 33 that is created in the annular flow channel 15 by orienting the gas inlet 13 tangentially to the flow channel is maintained by the helical guide plate 22. The helical guide plate 22 has an outer edge 44 and an inner edge 45. The outer edge 44 seals tightly against the inner side 20 of the cladding 17 of the main body 16, and the inner edge 45 fits tightly around the outer surface of the rod-shaped component 18. Such a helical shaped guide plate 22 may also be provided in the flow channels of the heat exchanger components 40 and 41.

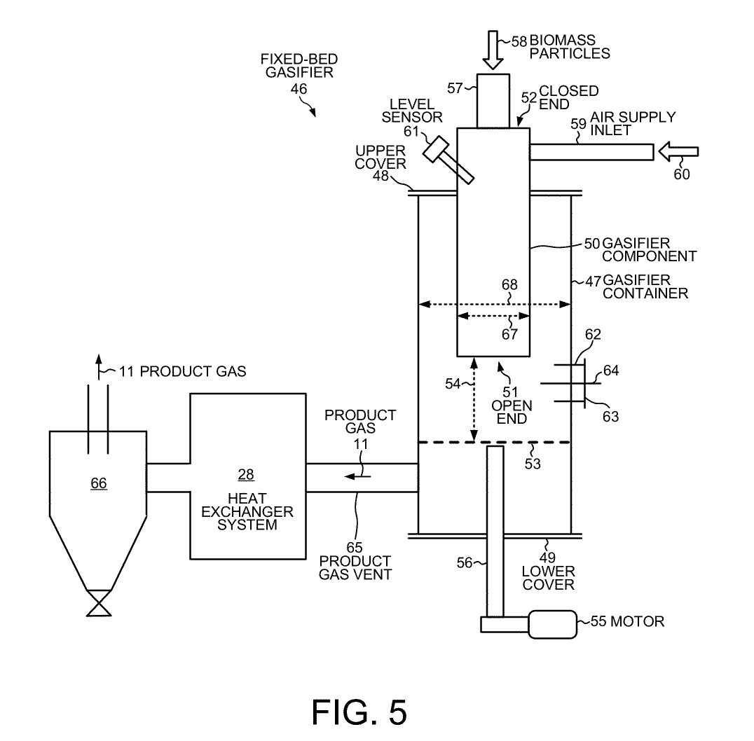

FIG. 5 is a schematic view of an exemplary configuration of a gasifier device 46 for producing a combustible product gas 11 from carbon-containing input materials. The gasifier device 46 uses a heat exchanger system 28 in accordance with FIG. 4. The gasifier device 46 includes a tubular gasifier container 47, whose ends are closed by an upper cover 48 and a lower cover 49.

A tubular gasifier component 50 has a lower open end 51 and an upper closed end 52. The gasifier component 50 projects with its lower open end 51 down into the gasifier container 47. The closed end 52 of the gasifier component 50 protrudes out through the upper cover 48 of the gasifier container 47. The open end 51 of gasifier component 50 lies approximately at the middle of the gasifier container 47. A rotary grate 53 is disposed in the gasifier container 47 at a distance 54 below the open end 51 of the gasifier component 50. The rotary grate 53 is moved periodically by a motor 55 and a drive shaft 56 that penetrates through the lower cover 49 of the gasifier container 47.

The upper, closed end 52 of the gasifier component 50 is penetrated by a supply inlet 57 for carbon-containing input materials such as pourable biomass particles 58, an air supply inlet 59 through which combustion air 60 enters the gasifier container 47, and a level sensor 61 by which the level of biomass particles 58 in the cylindrical gasifier component 50 is determined and monitored. An inspection shaft 62 penetrates the outer wall of the gasifier container 47 at the level of the open end 51 of the gasifier component 50. The inspection shaft 62 is closed by a covering flange 63 that is part of a temperature measurement device 64. The temperature in the gasifier container 47 is monitored using the temperature measurement device 64. Access into the reactor vessel can be gained through the inspection shaft 62 in order to perform maintenance and cleaning work inside the reactor vessel during the standstill of the reactor.

The product gas 11 is removed from the region of the gasifier container 47 beneath the grate 53 through a product gas vent 65. The product gas 11 is then cooled in the heat exchanger system 28 in accordance with FIG. 4 and purified in a downstream cyclone separator 66. The ashes falling through the grate 53 are also discharged from the gasifier container 47 through the product gas flow 11 via the product gas vent 65.

Both the tubular gasifier container 47 and the tubular gasifier component 50 have a circular cross-section and are arranged concentrically to one another. The tubular gasifier component 50 has an outer diameter 67 that is smaller than the inner diameter 68 of the tubular gasifier container 47.

### REFERENCE NUMERALS

10 heat exchanger component
11 gas flow with solid particles
12 solid particles
13 gas inlet of heat exchanger component
14 gas outlet of heat exchanger component
15 annular flow channel of main body
16 cylindrical main body
17 cladding of main body
18 rod-shaped component
19 Prandtl boundary layer
20 inner side of cladding
21 outer side of cladding
22 helical shaped guide plate
23 cylindrical container
24 flow channel for heat transfer medium
25 liquid heat transfer medium
26 cross-sectional area of gas outlet
27 cross-sectional area of gas inlet
28 heat exchanger system
29 left side of main body
30 right side of main body
31 left flange of main body
32 right flange of main body
33 helical flow stream
34 cross-sectional area of flow channel
35 heavier particles
36 lighter particles
37 heat exchanger component
38 inner side of container 23
39 first heat exchanger component of system 28
40 second heat exchanger component of system 28
41 third heat exchanger component of system 28
42 cross-sectional area of flow channel
43 cross-sectional area of flow channel
44 outer edge of guide plate
45 inner edge of guide plate
46 gasifier device
47 gasifier container
48 upper cover of gasifier container
49 lower cover of gasifier container
50 gasifier component
51 open end of gasifier component
52 closed end of gasifier component
53 rotary grate
54 distance of grate below gasifier component
55 motor
56 drive shaft
57 supply inlet for input materials
58 carbon-containing input materials
59 air supply inlet
60 combustion air
61 level sensor
62 inspection shaft
63 covering flange
64 temperature measurement device
65 product gas vent
66 cyclone separator
67 outer diameter of gasifier component
68 inner diameter of gasifier container

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1-15. (canceled)

16. A heat exchanger component, comprising:
a cylindrical main body with a first end, a second end and a circumferential cladding;
a rod-shaped component extending axially in the cylindrical main body from the first end to the second end, wherein an annular flow channel is formed around the rod-shaped component in the cylindrical main body;
a gas inlet disposed towards the first end, wherein the gas inlet is tubular and enters the annular flow channel tangentially to the circumferential cladding, and wherein the gas inlet has a first cross-sectional area; and
a gas outlet disposed towards the second end, wherein the gas outlet has a second cross-sectional area, and wherein the first cross-sectional area is larger than the second cross-sectional area.

17. The heat exchanger component of claim 16, wherein the cylindrical main body has an axial direction, and wherein the gas inlet enters the annular flow channel perpendicularly to the axial direction of the cylindrical main body.

18. The heat exchanger component of claim 16, wherein the gas outlet leads out of the annular flow channel tangentially to the cylindrical main body.

19. The heat exchanger component of claim 18, wherein the cylindrical main body has an axial direction, and wherein the gas outlet leads out of the annular flow channel perpendicularly to the axial direction of the cylindrical main body.

20. The heat exchanger component of claim 16, further comprising:
a helical shaped guide plate disposed in the annular flow channel.

21. The heat exchanger component of claim 20, wherein the helical shaped guide plate has an outer circumferential edge that seals tightly against an inner surface of the circumferential cladding.

22. The heat exchanger component of claim 21, wherein the helical shaped guide plate fits tightly around the rod-shaped component.

23. The heat exchanger component of claim 20, wherein the cylindrical main body has an axial direction, and wherein the helical shaped guide plate fully fills the annular flow channel when viewed in the axial direction of the cylindrical main body.

24. The heat exchanger component of claim 16, wherein the annular flow channel has a cross-sectional area that remains constant between the gas inlet and the gas outlet.

25. The heat exchanger component of claim 16, further comprising:
an outer cylindrical container, wherein the cylindrical main body is coaxially oriented inside the outer cylindrical container forming a channel between the circumferential cladding and the outer cylindrical container.

26. The heat exchanger component of claim 25, wherein a heat transfer medium is disposed in the channel formed between the circumferential cladding and the outer cylindrical container.

27. The heat exchanger component of claim 16, wherein the gas outlet has a length, and wherein the second cross-sectional area of the gas outlet remains constant throughout the length.

28. A heat exchanger system, comprising:
a first cylindrical main body with a left side, a right side and a first circumferential cladding;
a first gas inlet disposed towards the left side, wherein the first gas inlet is tubular and enters the first cylindrical main body tangentially to the first circumferential cladding, and wherein the first gas inlet has a first cross-sectional area;
a first gas outlet disposed towards the right side, wherein the first gas outlet has a second cross-sectional area, and wherein the first cross-sectional area is larger than the second cross-sectional area;
a second cylindrical main body with a first end, a second end and a second circumferential cladding;
a second gas inlet disposed towards the first end, wherein the second gas inlet is tubular and enters the second cylindrical main body tangentially to the second circumferential cladding, and wherein the second gas inlet has the second cross-sectional area and is connected to the first gas outlet; and
a second gas outlet disposed towards the second end, wherein the second gas outlet has a third cross-sectional area, and wherein the second cross-sectional area is larger than the third cross-sectional area.

29. The heat exchanger system of claim 28, further comprising:
a first rod-shaped component extending axially in the first cylindrical main body from the left side to the right side, wherein a first annular flow channel is formed around the first rod-shaped component in the first cylindrical main body; and
a second rod-shaped component extending axially in the second cylindrical main body from the first end to the second end, wherein a second annular flow channel is formed around the second rod-shaped component in the second cylindrical main body, and wherein the second annular flow channel has a cross-sectional area that is smaller than that of the first annular flow channel.

30. The heat exchanger system of claim 29, further comprising:
a helical shaped guide plate disposed in the first annular flow channel, wherein the helical shaped guide plate has an outer circumferential edge that seals tightly against an inner surface of the first circumferential cladding.

31. The heat exchanger system of claim 28, further comprising:
an outer cylindrical container, wherein the first cylindrical main body is coaxially oriented inside the outer cylindrical container forming a channel between the first cylindrical main body and the outer cylindrical container.

32. A device for producing a product gas from carbon-containing material, comprising:
a gasifier container with a first diameter;
a gasifier component with a second diameter, an upper closed end and a lower open end, wherein the upper closed end of the gasifier component projects up and out of the gasifier container, and wherein the first diameter is larger than the second diameter;
a supply inlet adapted to receive the carbon-containing material into the upper closed end of the gasifier component;
an air supply inlet that enters the gasifier component near the upper closed end and through which combustion air is fed into the gasifier component;
a grate adapted to support the carbon-containing material that is disposed in a lower portion of the gasifier container;
a product gas vent leading out of the gasifier container below the grate and through which the product gas generated from the carbon-containing material exits the gasifier container; and
a heat exchanger component that includes a gas inlet, a gas outlet and a cylindrical main body, wherein the gas inlet has a first cross-sectional area and the gas outlet has a second cross-sectional area, wherein the gas inlet is connected to the product gas vent, wherein the gas inlet enters the heat exchanger component tangentially to the cylindrical main body, and wherein the first cross-sectional area is larger than the second cross-sectional area.

33. The device of claim 32, wherein the gas outlet leads out of the heat exchanger component tangentially to the cylindrical main body.

34. The device of claim 32, wherein heat exchanger component includes a helical shaped guide plate disposed in the cylindrical main body.

35. The device of claim 32, wherein the cylindrical main body has a cross-sectional area that remains constant between the gas inlet and the gas outlet.
